(19) United States
(12) Patent Application Publication
(10) Pub. No.: US 2004/0093994 A1
(43) Pub. Date: May 20, 2004

(54) D-SHAPED HEADED RATCHET WRENCH STRUCTURE

(76) Inventor: Ching Jih Hsiao, Taiping City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/298,013

(22) Filed: Nov. 18, 2002

(51) Int. Cl. B25B 13/46

(52) U.S. Cl. 81/63.2

(57) ABSTRACT

A D-shaped headed ratchet wrench structure, comprising a drive head, a D-shaped head, an operation bar, a pawl member, a control ring, a direction control disk, an elastic member, and a C-shaped snap ring. Thus, the mounting end of the D-shaped head has a size different from that of the operation head of the operation bar, so that the mounting end of the D-shaped head and the operation head of the operation bar may be used to operate sockets having different sizes.

### BACKGROUND OF THE INVENTION

1. Field of the Invention

The present invention relates to a D-shaped headed ratchet wrench structure, and more particularly to a D-shaped headed ratchet wrench structure, wherein the mounting end of the D-shaped head has a size different from that of the operation head of the operation bar, so that the mounting end of the D-shaped head and the operation head of the operation bar may be used to operate sockets having different sizes.

2. Description of the Related Art

A conventional D-shaped headed ratchet wrench structure in accordance with the prior art of which the applicant is aware is disclosed in U.S. Pat. No. 5,916,339, entitled “ONE-WAY DRIVE MECHANISM AND CORRESPONDING RATCHET TOOL”. However, such a conventional D-shaped headed ratchet wrench structure can only be used to operate a socket of the same specification, and cannot be used to operate sockets of different sizes, thereby limiting the versatility of the conventional D-shaped headed ratchet wrench structure.

### SUMMARY OF THE INVENTION

The present invention has arisen to mitigate and/or obviate the disadvantage of the conventional D-shaped headed ratchet wrench structure.

The primary objective of the present invention is to provide a D-shaped headed ratchet wrench structure, wherein the operation head of the operation bar is protruded outward from the D-shaped head, so that the operation head of the operation bar may be pushed to retract the ball so as to detach the socket from the mounting end of the D-shaped head, thereby facilitating assembly and disassembly of the mounting end of the D-shaped head with the socket.

Another objective of the present invention is to provide a D-shaped headed ratchet wrench structure, wherein the mounting end of the D-shaped head has a size different from that of the operation head of the operation bar, so that the mounting end of the D-shaped head and the operation head of the operation bar may be used to operate sockets having different sizes.

In accordance with the present invention, there is provided a D-shaped headed ratchet wrench structure, comprising a drive head, a D-shaped head, an operation bar, a pawl member, a control ring, a direction control disk, and an elastic member, wherein:

the drive head is formed with a receiving hole which has a periphery provided with multiple engaging teeth;

the D-shaped head is mounted in the receiving hole of the drive head, and has a periphery formed with a resting face, so that a locking space is formed between the resting face of the D-shaped head and the receiving hole of the drive head, the D-shaped head has a bottom provided with a mounting end protruded outward from a bottom of the drive head and a top protruded outward from a top of the drive head, the D-shaped head has an inner wall formed with a stepped hole, the stepped hole of the D-shaped head has an upper portion formed with a first face, a mediate portion formed with a shoulder and a lower portion formed with a second face;

the operation bar is slidably mounted in the stepped hole of the D-shaped head, and has an upper portion formed with an operation head mounted in the first face of the stepped hole of the D-shaped head and a lower portion formed with a rod mounted in the second face of the stepped hole of the D-shaped head, the operation head of the operation bar is protruded outward from the stepped hole of the D-shaped head, and the rod of the operation bar is formed with a cavity for receiving a ball;

the pawl member is pivotally and movably mounted in the locking space defined between the resting face of the D-shaped head and the receiving hole of the drive head, and has a periphery provided with multiple locking teeth meshing with the engaging teeth of the drive head;

the control ring is mounted on the top of the D-shaped head, and is provided with a control leg secured on the pawl member for pivoting and moving the pawl member;

the direction control disk is mounted on the top of the drive head, and has a bottom provided with a control shaft secured on the control ring for rotating the control ring; and

the elastic member is mounted on the rod of the operation bar, and is urged between the operation head of the operation bar and the shoulder of the stepped hole of the D-shaped head.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a D-shaped headed ratchet wrench structure in accordance with a first embodiment of the present invention;

FIG. 2 is a perspective assembly view of the D-shaped headed ratchet wrench structure in accordance with the first embodiment of the present invention;

FIG. 3 is a top plan view of the D-shaped headed ratchet wrench structure as shown in FIG. 2;

FIG. 3A is a cross-sectional view of the D-shaped headed ratchet wrench structure as shown in FIG. 3;

FIG. 4 is a top plan view of the D-shaped headed ratchet wrench structure as shown in FIG. 2;

FIG. 4A is a schematic operational view of the D-shaped headed ratchet wrench structure as shown in FIG. 3A in use;

FIG. 5 is a schematic operational view of the D-shaped headed ratchet wrench structure as shown in FIG. 2 in use;

FIG. 6 is a schematic operational view of the D-shaped headed ratchet wrench structure as shown in FIG. 2 in use;

FIG. 7 is a schematic top plan operational view of the D-shaped headed ratchet wrench structure as shown in FIG. 2 in use;

FIG. 8 is an exploded perspective view of a D-shaped headed ratchet wrench structure in accordance with a second embodiment of the present invention;

FIG. 9 is a top plan view of the D-shaped headed ratchet wrench structure as shown in FIG. 8;

FIG. 9A is a cross-sectional view of the D-shaped headed ratchet wrench structure as shown in FIG. 9; and

FIG. 10 is a perspective view of a D-shaped headed ratchet wrench structure in accordance with a third embodiment of the present invention.

### DETAILED DESCRIPTION OF THE INVENTION

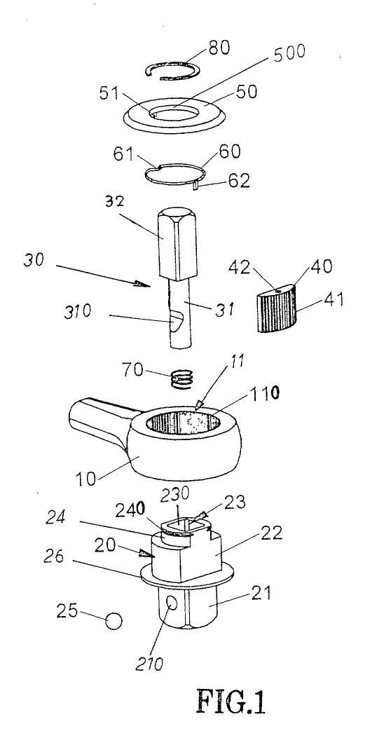

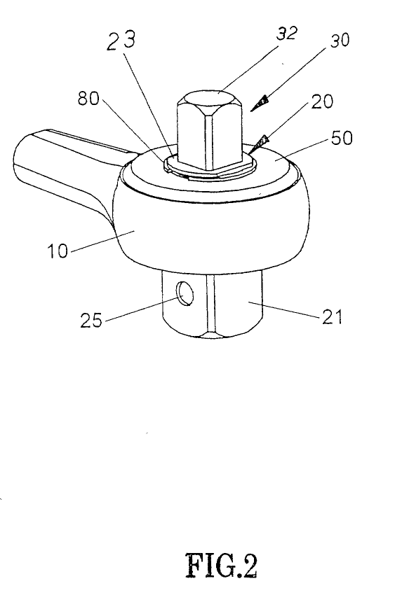

Referring to the drawings and initially to FIGS. 1-3 and 3A, a D-shaped headed ratchet wrench structure in accordance with a first embodiment of the present invention comprises a drive head 10, a D-shaped head 20, an operation bar 30, a pawl member 40, a control ring 60, a direction control disk 50, an elastic member 70, and a C-shaped snap ring 80.

The drive head 10 is formed with a receiving hole 11 which has a periphery provided with multiple engaging teeth 110.

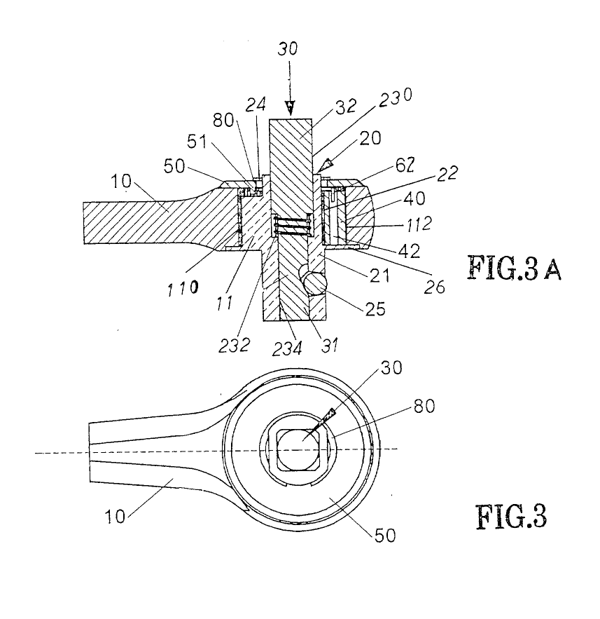

The D-shaped head 20 is mounted in the receiving hole 11 of the drive head 10, and has a periphery formed with a flat chambered resting face 22, so that a locking space 112 (see FIG. 3A) is formed between the resting face 22 of the D-shaped head 20 and the receiving hole 11 of the drive head 10. The D-shaped head 20 has a bottom provided with a support disk 26 rested on a bottom of the drive head 10. The D-shaped head 20 is provided with a square mounting end 21 extended outward from the support disk 26 and formed with a locking hole 210 for receiving and locking a ball 25. The D-shaped head 20 has a top provided with a stepped portion 24 protruded outward from a top of the drive head 10 and having an outer wall formed with a snapping groove 240. The D-shaped head 20 has an inner wall formed with a stepped hole 23 which has an upper portion formed with a square face 230, a mediate portion formed with a shoulder 232 and a lower portion formed with a circular face 234.

The operation bar 30 is slidably mounted in the stepped hole 23 of the D-shaped head 20, and has an upper portion formed with a square operation head 32 mounted in the square face 230 of the stepped hole 23 of the D-shaped head 20 and a lower portion formed with a rod 31 mounted in the circular face 234 of the stepped hole 23 of the D-shaped head 20. The operation head 32 of the operation bar 30 is protruded outward from the stepped hole 23 of the D-shaped head 20. The rod 31 of the operation bar 30 is formed with a cavity 310 for receiving the ball 25.

The pawl member 40 is pivotally and movably mounted in the locking space 112 (see FIG. 3A) defined between the resting face 22 of the D-shaped head 20 and the receiving hole 11 of the drive head 10, and has a periphery provided with multiple locking teeth 41 meshing with the engaging teeth 110 of the drive head 10. The pawl member 40 has a top formed with a control hole 42.

The control ring 60 having a slightly elastic feature is mounted on the stepped portion 24 of the D-shaped head 20. The control ring 60 is provided with a control leg 62 inserted into the control hole 42 of the pawl member 40 and is formed with a locking recess 61 located radially opposite to the control leg 62.

The direction control disk 50 is mounted on the top of the drive head 10, and is formed with a hole 500 for passage of the stepped portion 24 of the D-shaped head 20. The direction control disk 50 has a bottom provided with a control shaft 51 inserted into the locking recess 61 of the control ring 60.

The elastic member 70 is mounted on the rod 31 of the operation bar 30, and is urged between the operation head 32 of the operation bar 30 and the shoulder 232 of the stepped hole 23 of the D-shaped head 20.

The C-shaped snap ring 80 is secured in the snapping groove 240 of the stepped portion 24 of the D-shaped head 20, and is rested on a top of the direction control disk 50, thereby preventing the direction control disk 50 from detaching from the top of the drive head 10.

In assembly, the D-shaped head 20 is mounted in the receiving hole 11 of the drive head 10 from the bottom of the drive head 10, with the support disk 26 of the D-shaped head 20 being rested on the bottom of the drive head 10. Then, the pawl member 40 is mounted in the locking space 112 (see FIG. 3A) defined between the resting face 22 of the D-shaped head 20 and the receiving hole 11 of the drive head 10. Then, the control ring 60 is mounted on the stepped portion 24 of the D-shaped head 20, with the control leg 62 of the control ring 60 being inserted into the control hole 42 of the pawl member 40. Then, the elastic member 70 is mounted on the rod 31 of the operation bar 30, and the operation bar 30 is slidably mounted in the stepped hole 23 of the D-shaped head 20, with the elastic member 70 being urged between the operation head 32 of the operation bar 30 and the shoulder 232 of the stepped hole 23 of the D-shaped head 20, and with the cavity 310 of the operation bar 30 aligning with the ball 25. Then, the direction control disk 50 is mounted on the top of the drive head 10, with the control shaft 51 of the direction control disk 50 being inserted into the locking recess 61 of the control ring 60. Finally, the C-shaped snap ring 80 is secured in the snapping groove 240 of the stepped portion 24 of the D-shaped head 20, and is rested on the top of the direction control disk 50, thereby preventing the direction control disk 50 from detaching from the top of the drive head 10.

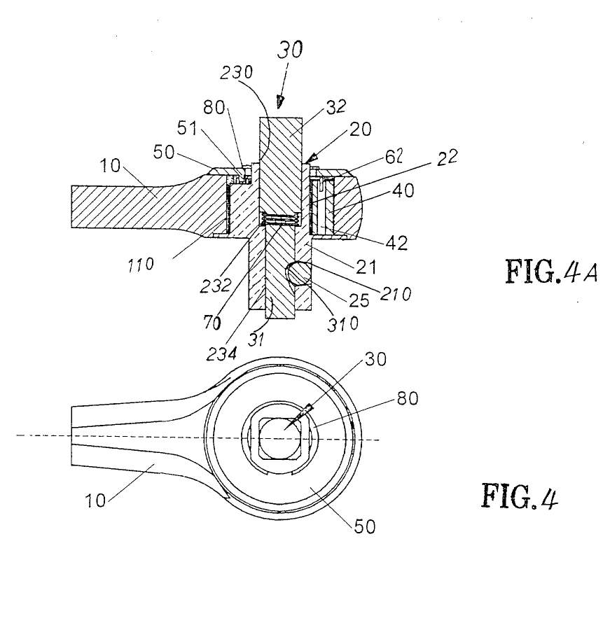

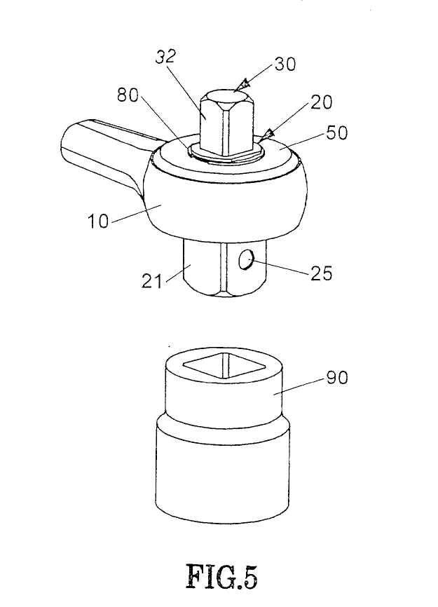

In operation, referring to FIGS. 4 and 4A, when the operation head 32 of the operation bar 30 is pushed, the operation head 32 of the operation bar 30 is moved in the stepped hole 23 of the D-shaped head 20 to compress the elastic member 70, so that when the cavity 310 of the operation bar 30 is moved to align with the ball 25, the ball 25 is retracted into and received in the cavity 310 of the operation bar 30 as shown in FIG. 4A, thereby detaching the socket 90 from the mounting end 21 of the D-shaped head 20 as shown in FIG. 5.

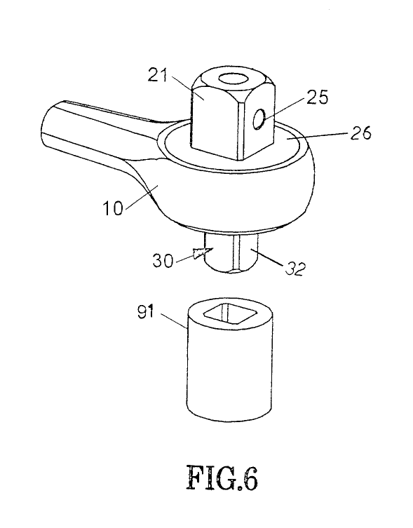

Referring to FIGS. 5 and 6, the mounting end 21 of the D-shaped head 20 has a size different from that of the operation head 32 of the operation bar 30, so that the mounting end 21 of the D-shaped head 20 may be used to operate a socket 90 having a larger size as shown in FIG. 5, and the operation head 32 of the operation bar 30 may be used to operate a socket 91 having a smaller size as shown in FIG. 6.

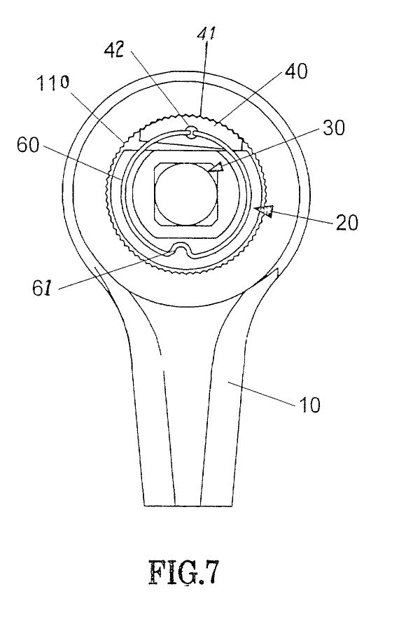

Referring to FIG. 7 with reference to FIG. 1, the direction control disk 50 is rotated to rotate the control ring 60 which moves the control leg 62 which moves and pivots the pawl member 40, so that the pawl member 40 is moved to press one side of the resting face 22 of the D-shaped head 20, with the locking teeth 41 the pawl member 40 meshing with the engaging teeth 110 of the drive head 10. Thus, rotation of the drive head 10 may drive the D-shaped head 20 to rotate in the clockwise or counterclockwise direction.

Accordingly, in the D-shaped headed ratchet wrench structure in accordance with the present invention, the operation head 32 of the operation bar 30 is protruded outward from the D-shaped head 20, so that the operation head 32 of the operation bar 30 may be pushed to retract the ball 25 so as to detach the socket 90 from the mounting end 21 of the D-shaped head 20, thereby facilitating assembly and disassembly of the mounting end 21 of the D-shaped head 20 with the socket 90. In addition, the mounting end 21 of the D-shaped head 20 has a size different from that of the operation head 32 of the operation bar 30, so that the mounting end 21 of the D-shaped head 20 and the operation head 32 of the operation bar 30 may be used to operate sockets having different sizes.

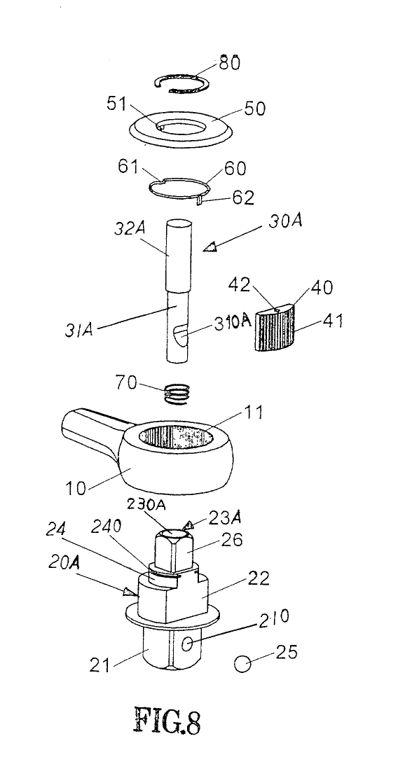

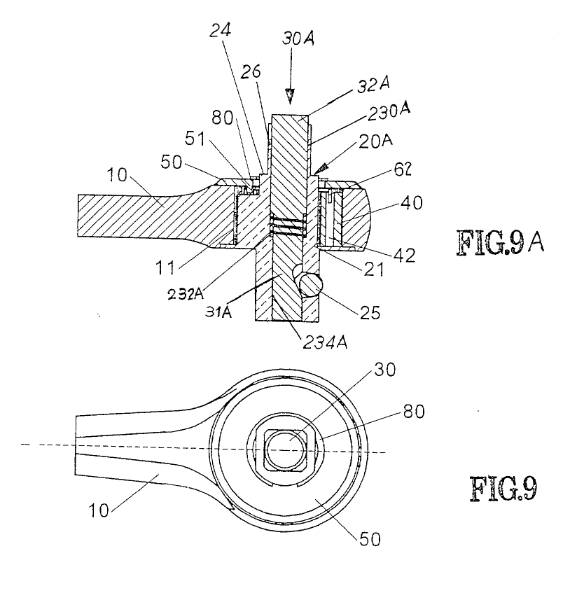

Referring to FIGS. 8, 9 and 9A, a D-shaped headed ratchet wrench structure in accordance with a second embodiment of the present invention is shown, wherein most of the parts of the D-shaped headed ratchet wrench structure in accordance with the second embodiment of the present invention are the same as that of the D-shaped headed ratchet wrench structure in accordance with the first embodiment of the present invention, and the difference therebetween is described as follows.

The D-shaped head 20A is provided with a square lug 26 extended outward from the stepped portion 24 and protruded outward from the top of the drive head 10. The D-shaped head 20A has an inner wall formed with a stepped hole 23A which has an upper portion formed with a circular face 230A, a mediate portion formed with a shoulder 232A and a lower portion formed with a reduced circular face 234A.

The operation bar 30A is slidably mounted in the stepped hole 23A of the D-shaped head 20A, and has an upper portion formed with a circular operation head 32A mounted in the circular face 230A of the stepped hole 23A of the D-shaped head 20A and a lower portion formed with a rod 31A mounted in the circular face 234A of the stepped hole 23A of the D-shaped head 20A. The operation head 32A of the operation bar 30A is protruded outward from the stepped hole 23A of the D-shaped head 20A. The rod 31A of the operation bar 30A is formed with a cavity 310A for receiving the ball 25.

In such a manner, the mounting end 21 of the D-shaped head 20A has a size different from that of the lug 26 of the D-shaped head 20A, so that the mounting end 21 of the D-shaped head 20A and the lug 26 of the D-shaped head 20A may be used to operate sockets having different sizes.

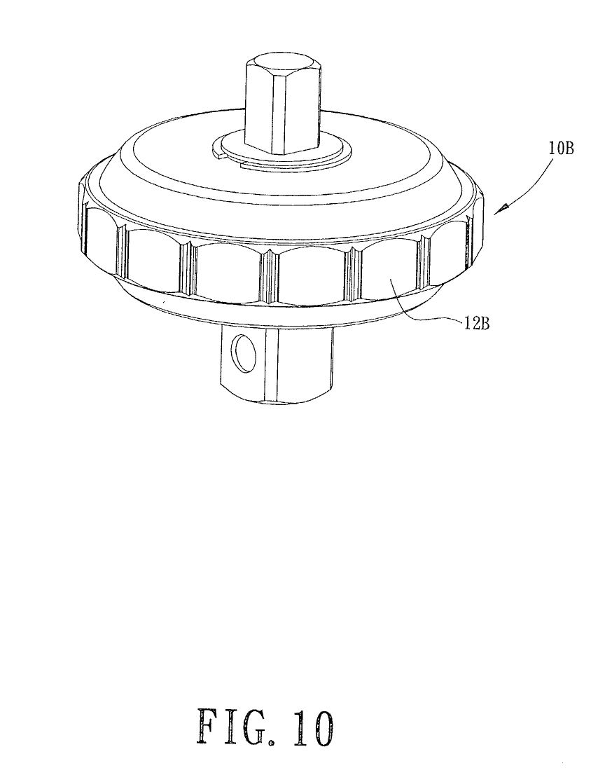

Referring to FIG. 10, a D-shaped headed ratchet wrench structure in accordance with a third embodiment of the present invention is shown, wherein the drive head 10B has a polygonal outer wall formed with multiple holding faces 12B, thereby facilitating the user holding and rotating the drive head 10B.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A D-shaped headed ratchet wrench structure, comprising a drive head, a D-shaped head, an operation bar, a pawl member, a control ring, a direction control disk, and an elastic member, wherein:
the drive head is formed with a receiving hole which has a periphery provided with multiple engaging teeth;
the D-shaped head is mounted in the receiving hole of the drive head, and has a periphery formed with a resting face, so that a locking space is formed between the resting face of the D-shaped head and the receiving hole of the drive head, the D-shaped head has a bottom provided with a mounting end protruded outward from a bottom of the drive head and a top protruded outward from a top of the drive head, the D-shaped head has an inner wall formed with a stepped hole, the stepped hole of the D-shaped head has an upper portion formed with a first face, a mediate portion formed with a shoulder and a lower portion formed with a second face;
the operation bar is slidably mounted in the stepped hole of the D-shaped head, and has an upper portion formed with an operation head mounted in the first face of the stepped hole of the D-shaped head and a lower portion formed with a rod mounted in the second face of the stepped hole of the D-shaped head, the operation head of the operation bar is protruded outward from the stepped hole of the D-shaped head, and the rod of the operation bar is formed with a cavity for receiving a ball;
the pawl member is pivotally and movably mounted in the locking space defined between the resting face of the D-shaped head and the receiving hole of the drive head, and has a periphery provided with multiple locking teeth meshing with the engaging teeth of the drive head;
the control ring is mounted on the top of the D-shaped head, and is provided with a control leg secured on the pawl member for pivoting and moving the pawl member;
the direction control disk is mounted on the top of the drive head, and has a bottom provided with a control shaft secured on the control ring for rotating the control ring; and
the elastic member is mounted on the rod of the operation bar, and is urged between the operation head of the operation bar and the shoulder of the stepped hole of the D-shaped head.

2. The D-shaped headed ratchet wrench structure in accordance with claim 1, wherein the top of the D-shaped head is provided with a stepped portion protruded outward from the top of the drive head and having an outer wall formed with a snapping groove, and the D-shaped headed ratchet wrench structure further comprises a C-shaped snap ring secured in the snapping groove of the stepped portion of the D-shaped head and rested on a top of the direction control disk, thereby preventing the direction control disk from detaching from the top of the drive head.

3. The D-shaped headed ratchet wrench structure in accordance with claim 1, wherein the D-shaped head has a bottom provided with a support disk rested on a bottom of the drive head.

4. The D-shaped headed ratchet wrench structure in accordance with claim 1, wherein the first face of the stepped hole of the D-shaped head has a square shape, and the operation head of the operation bar has a square shape.

5. The D-shaped headed ratchet wrench structure in accordance with claim 1, wherein the first face of the stepped hole of the D-shaped head has a circular shape, and the operation head of the operation bar has a circular shape.

6. The D-shaped headed ratchet wrench structure in accordance with claim 1, wherein the pawl member has a top formed with a control hole, and the control leg of the control ring is inserted into the control hole of the pawl member.

7. The D-shaped headed ratchet wrench structure in accordance with claim 1, wherein the control ring is formed with a locking recess located radially opposite to the control leg, and the control shaft of the direction control disk is inserted into the locking recess of the control ring.

8. The D-shaped headed ratchet wrench structure in accordance with claim 1, wherein the mounting end of the D-shaped head has a size different from that of the operation head of the operation bar.

9. The D-shaped headed ratchet wrench structure in accordance with claim 1, wherein the top of the D-shaped head is provided with a lug extended outward and protruded outward from the top of the drive head.

10. The D-shaped headed ratchet wrench structure in accordance with claim 1, wherein the lug of the D-shaped head has a square shape.

11. The D-shaped headed ratchet wrench structure in accordance with claim 1, wherein the drive head has a polygonal outer wall formed with multiple holding faces, thereby facilitating the user holding and rotating the drive head.
